(19) United States
(12) Patent Application Publication
(10) Pub. No.: US 2016/0063527 A1
(43) Pub. Date: Mar. 3, 2016

(54) GENERATING CUSTOMER LISTS USING INTERPOLATED DATA DERIVED FROM SEVERE WEATHER INCIDENT DATA

(71) Applicant: Brett MacDonald, Stillwater, MN (US)

(72) Inventor: Brett MacDonald, Stillwater, MN (US)

(21) Appl. No.: 14/839,341

(22) Filed: Aug. 28, 2015

Related U.S. Application Data
(60) Provisional application No. 62/042,904, filed on Aug. 28, 2014.

(51) Int. Cl. G06Q 30/02

(52) U.S. Cl. CPC G06Q 30/0205; G06Q 30/0201

(57) ABSTRACT

A method of generating a list of targeted customers for a sales representative within a territory affected by a severe weather incident is provided using severe weather incident data, such as hailstone size, retrieved from a first database and customer data retrieved from a second database. The customer data and severe weather incident data are displayed onto a map viewable by a user and a targeted customer list is generated based on at least one user-selected parameter and the intersection of customer data points with weather data points.

### CROSS-REFERENCE TO RELATED APPLICATIONS

This application claims priority to Application Ser. No. 62/042,904, entitled “Generating Customer Lists from Interpolated Data” and filed on Aug. 28, 2014, and which is hereby incorporated by reference herein in its entirety.

### FIELD OF THE INVENTION

The present disclosure relates generally to generating customer lists from interpolated data. Particularly, the present disclosure relates to generating customer lists from interpolated data based on geographic locations and other user-selected characteristics.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

When severe weather phenomena cause storm damage to properties, companies often attempt to solicit owners of storm-damaged properties to utilize their repair services. Given that the storm damage path is generally a non-linear swath of damage and the degree of severity of damage can vary significantly, it is often difficult and time-consuming for companies to target owners of storm-damaged properties. Additionally, owners of properties in several geographic locations may wish to remotely receive information regarding storm-damaged properties requiring their attention. Current methodologies require a construction company employee or a property owner to visit multiple properties that may or may not require inspection and repair depending on their location or certain property characteristics, rather than targeting specific properties within the storm damage path. There is a need in the industry for a reliable means for efficiently generating a targeted list of properties affected by storm damage that may require construction, repair or other maintenance services in order to assist property owners more promptly. The more promptly repair services can be rendered, the more likely that additional damage can be prevented and that a property owner's insurance will cover the costs of the repair.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, is directed to a method of generating a list of targeted properties for a user, the method comprising obtaining first data from a first database, the first data comprising a first set of data points for a user-selected region, the first set of data points determined from at least one of the group comprising weather incident data and property data; obtaining second data from a second database, the second data comprising a second set of data points determined by a set of user-selected characteristics; and combining the second data and the first data into a map, wherein the first set of data points intersect the second set of data points to form a third set of data points, wherein the third set of data points determine the list of targeted properties. In some embodiments, the method further comprises exporting the third set of data points into at least one of a third database and a tabular format file. Property data may refer to at least real property or personal property based on their location, such as vehicles stored at a car dealership, storage facility, or auction facility.

In some embodiments, the method further comprises selecting a specific region of the map to further limit the third set of data points to a region-specific targeted list. To select the specific region, the user may in some embodiments draw a perimeter around the specific region; in other embodiments, the user may highlight the desired area.

In at least one embodiment, the third set of data points may be used to generate an alert or alarm to alert a user to visit or inspect a property.

The present disclosure is further directed to a generated list for a user, the list comprising interpolated data derived from the intersection of first set of data points from first data and a second set of data points from second data, the first data obtained from a first database and the first set of data points derived from at least one of the group comprising weather incident data and real property data, the second data obtained from a second database and the second set of data points determined by a set of user-selected characteristics. In at least one embodiment, the user is a property manager, residential or multi-residential property owner, commercial property owner, municipality, home-owners' association, or the like (collectively referred to herein as “property owner/manager”) with a subscription to a list generating service that utilizes the methods described herein to generate a targeted list and the user-selected characteristics comprise at least the one or more properties managed or owned by the property owner/manager.

In some embodiments, the present disclosure is directed to a method of generating a list of targeted customers for a sales representative within a territory affected by a severe weather incident, the method comprising: retrieving severe weather incident data for at least one severe weather incident from a first database, the severe weather incident data comprising weather data points defining a severe weather pattern; retrieving customer data from a second database, the customer data comprising data for each of a plurality of customers, and for each customer a customer data point defining a geographic location related to that respective customer; displaying the customer data points and the severe weather pattern onto a map viewable by a user, wherein the customer data points are geocoded for display on the map; and transmitting a targeted customer list, wherein the targeted customer list is determined by at least one user-selected parameter and the intersection of customer data points with weather data points. At least one user-selected parameter may be a selected region of the map to further limit the targeted customer list to the selected region. In some embodiments, the severe weather incident data comprises data related to hail and at least one user-selected parameter may be hailstone size. In some embodiments, the severe weather incident data comprises data related to damaging winds, and the at least one user-selected parameter may be wind speeds. In at least one embodiment, the severe weather incident data comprises data related to snow and at least one user-selected parameter may be snow depth. In at least one embodiment, the severe weather incident data comprises data related to rain and the at least one user-selected parameter may be an amount of rainfall during the severe weather incident. In one embodiment, at least one user-selected parameter comprises all severe weather incident data for a selected date. In some embodiments, The user-selected characteristics may comprises at least one of existing customers, past customers, new customers, user-managed properties, referral source, dates and times of scheduled inspections, number of call attempts, roofing materials, siding materials, and driveway materials. The method may further comprise generating an alert from the targeted customer list to alert a user to visit a property. In some embodiments, the method may further comprise assigning the targeted customer list to a representative for the territory. In some embodiments, the customer data is automatically updated from information retrieved from a third party database.

In some embodiments, the present disclosure is directed to a method of generating a list of targeted customers within a specified region of a territory. The method may comprise retrieving severe weather incident data for at least one severe weather incident from a first database, the severe weather incident data comprising weather data points defining a severe weather pattern; retrieving customer data from a second database, the customer data comprising customer data points; displaying the customer data points and the severe weather pattern onto a map viewable by a user, wherein the customer data points are geocoded for display on a map; retrieving boundary information for a region within the map selected by a user; and transmitting a targeted customer list to the user, wherein the targeted customer list is determined by the intersection of customer data points with weather data points and the boundary information for the region. The weather incident data may comprise data related to at least one of hail accumulation, hailstone size, snow accumulation, flooding, wind gusts, sustained high winds, lightning strikes, severe storm paths, tornado paths, hurricane paths, and seismic activity. In some embodiments, the method may further comprise the targeted customer list to a representative. In some embodiments, the targeted customer list is further determined by at least one user-selected characteristic, wherein the user-selected characteristics may comprise at least one of existing customers, past customers, new customers, user-managed properties, referral source, dates and times of scheduled inspections, number of call attempts, roofing materials, siding materials, and driveway materials.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying figures, in which:

FIG. 1 is a flow diagram for one embodiment of generating the customer lists from interpolated data in accordance with the various embodiments of the present disclosure.

FIG. 2 is an example of one embodiment of a user interface of the present disclosure.

FIG. 3 is an example of a selected territory screen for one embodiment of the user interface.

FIG. 4 is an example of a first map of the present disclosure.

FIGS. 5A and 5B are examples of first maps of the present disclosures.

FIG. 6 is an example of a second map of the present disclosure.

FIG. 7 is an example of a third map of the present disclosure.

FIG. 8 is another view of the map shown in FIG. 7.

FIG. 9 is another view of the map shown in FIGS. 7-8.

FIG. 10 is another view of the map shown in FIGS. 7-9.

FIG. 11 is another view of the map shown in FIGS. 7-10.

FIG. 12 is an example of the reporting feature of the user interface.

FIG. 13 is another view of the reporting feature shown in FIG. 12.

FIG. 14 is another view of the reporting feature shown in FIGS. 12-13.

FIG. 15 is another view of the reporting feature shown in FIG. 14.

FIG. 16 is an example of the customer feature of the user interface.

### DETAILED DESCRIPTION

The present disclosure relates to novel and advantageous systems and methods for generating a targeted list of customers or properties for a particular weather-related event or other property-related event. Particularly, the present disclosure relates to novel and advantageous systems and methods for generating a targeted list of customers or properties based on particular weather-related event information obtained from a first database and a selected set of customers or properties obtained from a second database.

For purposes of this disclosure, any system or information handling system used for the methods described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially” free of or “generally” free of an ingredient or element may still actually contain such item as long as there is generally no measurable effect thereof.

Although the embodiments described herein refer particularly to hail storm data such as hail accumulation and hailstone size, the inventive methods and user-generated lists described herein are suitable for any weather incident data, including, but not limited to, data related to hail accumulation, hailstone size, snow accumulation, flooding, wind gusts, sustained high winds, lightning strikes, severe storm paths, tornado paths, hurricane paths, and/or seismic activity. The inventive methods and user-generated lists described herein are suitable for any property based incident and incident data may also include power outages, internet outages, or other utility outages, which may or may not be caused by severe weather. Each of these weather incidents, utility outage incidents, or other incidents such as criminal activity or construction activity, typically involve an affected area, with some locations being affected more severely than others. In at least one embodiment, depending on the incident, the affected area may be considered a pattern of activity. Additionally, the methods are suitable for determining other data related to real property, including but not limited to property sales over a particular time period, business information, property taxes, building permits, road construction information, vehicle accidents, and/or crime reports. Further, the methods may be suitable for data related to semi-trailer or other transportation means in order to help direct semi-trailers around weather- related patterns or accident conditions that may affect timely transport or pick-up of goods often carried by the semi-trailers. Still further, the methods may be suitable for, based on weather patterns for example, determining the potential financial impact of a storm to insurance companies, more effective insurance adjuster deployment, more efficient inventory management for building materials manufacturers and/or distributors, and the like.

The methods and user-generated lists described herein are suitable for use by various users, including but not limited to property owners/managers and company employees such as sales representatives. In at least one embodiment, the methods described herein may be offered to property owners/managers in the form of a Software as a Service (SaaS) application. Property owners/managers may subscribe to the SaaS application, which may display a generated list of properties that may require inspection. The generated list may be displayed through a graphic user interface on a laptop, computer, mobile device, smart phone, tablet or other electronic display device, or the generated list may be sent to the property owner/manager via e-mail, text message, or other text-based or multimedia-messaging communication medium such as email, Short Message Service (SMS), or Multimedia Messaging Service (MMS). In other embodiments, the methods may be used by a user to identify new clients or customers, or to target existing customers or past customers.

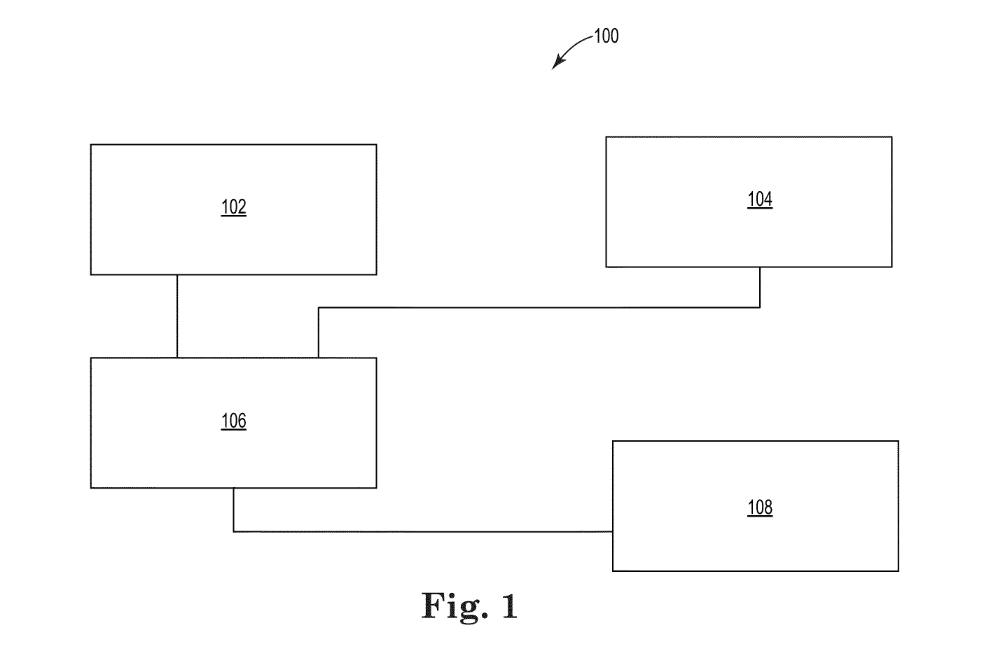

FIG. 1 shows one embodiment of a method 100 for generating a targeted list from interpolated data, for instance generating a targeted list of properties that likely have been damaged by hail. In at least the embodiment shown, the method comprises, as shown at 102, obtaining first data or a first map from a first database. The first database may be remotely, and in some embodiments, may be, but is not necessarily, operated by a third party. The first data or first map is derived from at least one of weather incident data (such as hail storm data) or other data related to real property as discussed above. As shown at 104, a second data or second map is obtained from a second database generated by the user, the second data or second map comprises a second set of data points determined by a set of one or more user-selected characteristics, which may include, but are not limited to, prior customers of the user, potential new customers, user-managed properties, referral source information, dates and times of scheduled inspections, number of call attempts, roofing materials, siding materials, driveway materials, or other customer-related or property-related information. In at least one embodiment, where the method is used by a property owner/manager, the one or more user-selected characteristics include the user-managed properties. The first data or first map and the second data or second map are then combined into a third map, as shown at 106, wherein data points of the first map intersect the data points of the second map to form a third set of data points. The third map allows a user to visually identify targeted properties for sales representatives or for property owners/managers to visually identify user-managed properties that may be damaged by the hail storm, depending on whether the user is an employee of the company or a property owner/manager. The third set of data points may be outputted to a sales representative's smart phone, tablet, or other mobile device, either manually at the direction of the user or automatically by the system. The third set of data points may be exported into a file format such as a Common-Separated Values (CSV) file format or other tabular file format. The third set of data points may be outputted to display the generated list through a graphical user interface of the SaaS application for subscription users such as property owners/managers. The third set of data points may also be used by property owners/managers to evaluate a need for inspection of their properties. The third set of data points may be used to activate an alarm for a property owner/manager, alerting the property owner/manager to inspect or schedule an inspection of the property. The third set of data points may be used by sales representatives in the field to make timely visits to potentially hail damaged property. The third set of data points may also be used internally for sales calls, to generate mailing lists, to identify areas for advertising, to determine the number of customers within proximity to distributors thus allowing for efficient inventory management, to determine the number of insurance policy holders in an area thus allowing for efficient deployment of property adjusters or calculation of potential financial impact, for assigning sales or distributor territory assignments, etc.

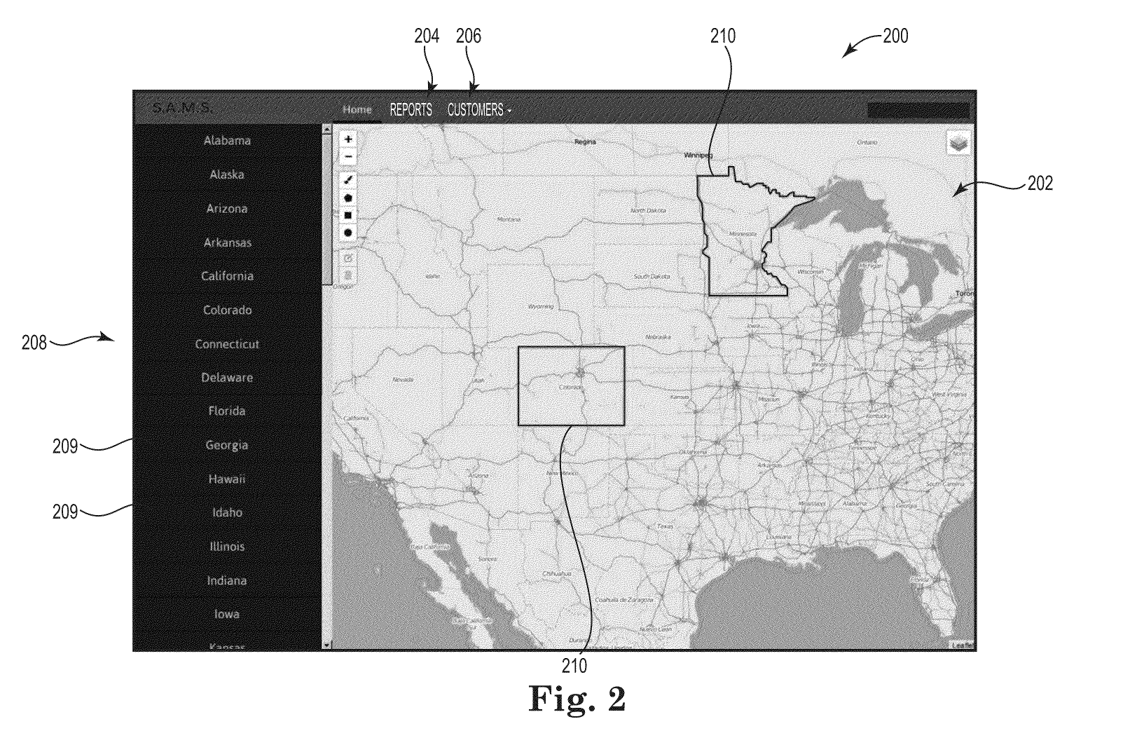

FIGS. 2-16 show screenshots of one embodiment of a user interface of the present disclosure. While the disclosure herein describes various embodiments of the invention with respect to these figures showing one embodiment of the user interface, other embodiments having one or more of the features described herein are contemplated.

FIG. 2 shows a screenshot of an initial screen 200, or a home screen, of the user interface. In the embodiment shown, the user interface has a map feature 202, a reporting feature 204, and a customer feature 206. Further, as shown in the embodiment in FIG. 2, the user interface has a territory selection feature 208 which may show a number of territories. The user may select one or more territories 209 for which the user desires to generate a customer list derived from the weather incident data for the selected territory or territories. A territory may be a district, a township, a city, a state, a region, a country, or any other geographic area. In at least one embodiment, a user may only select an available territory or territories 210 from the territories 209, and the available territory 210 may be displayed on the map feature 202, such as by an outline, shading, highlighting, or the like, as shown. An available territory may be a territory that the user has paid a subscription fee to obtain the data, a territory within which the user has clients or customers, a territory defined by property owned by the user, or any territory where data has been collected. The available territories 210 as shown in FIG. 2 are shown as entire states, but the available territories could be any territory.

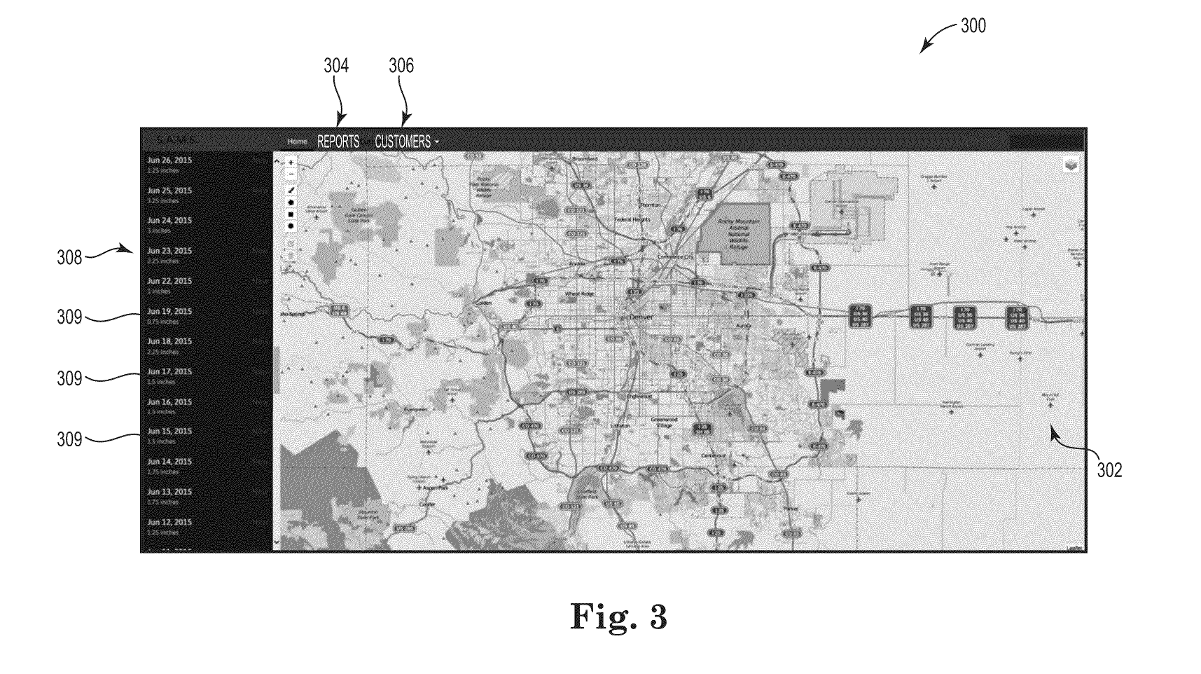

Once a territory has been selected, a selected territory screen 300 of the user interface is displayed as shown FIG. 3. In the embodiment shown, the user interface has a map feature 302 that displays at least a portion of the selected territory, a reporting feature 304, a customer feature 306, and further comprises a weather incident selection feature 308 which may show a number of weather incidents available for selection and display. The user may select one or more weather incidents 309 within the selected territory to obtain first data for the first map. The selectable weather incidents may be organized by date as shown in FIG. 3, or may be organized by severity, duration, population density of the incident, or other factors.

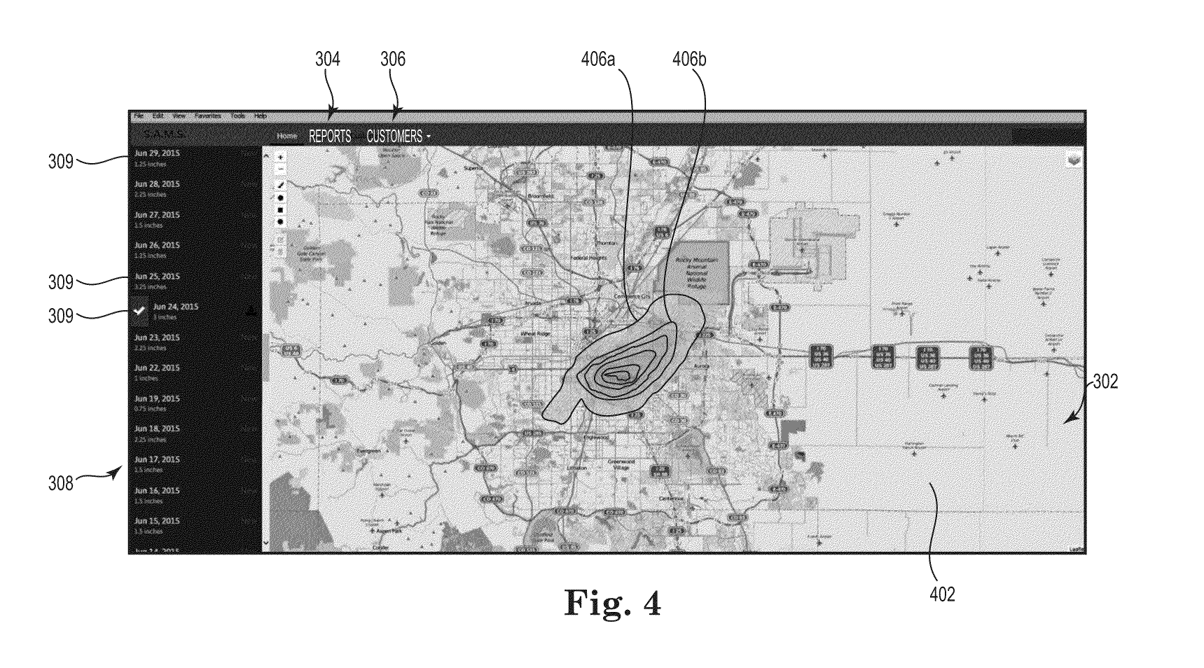

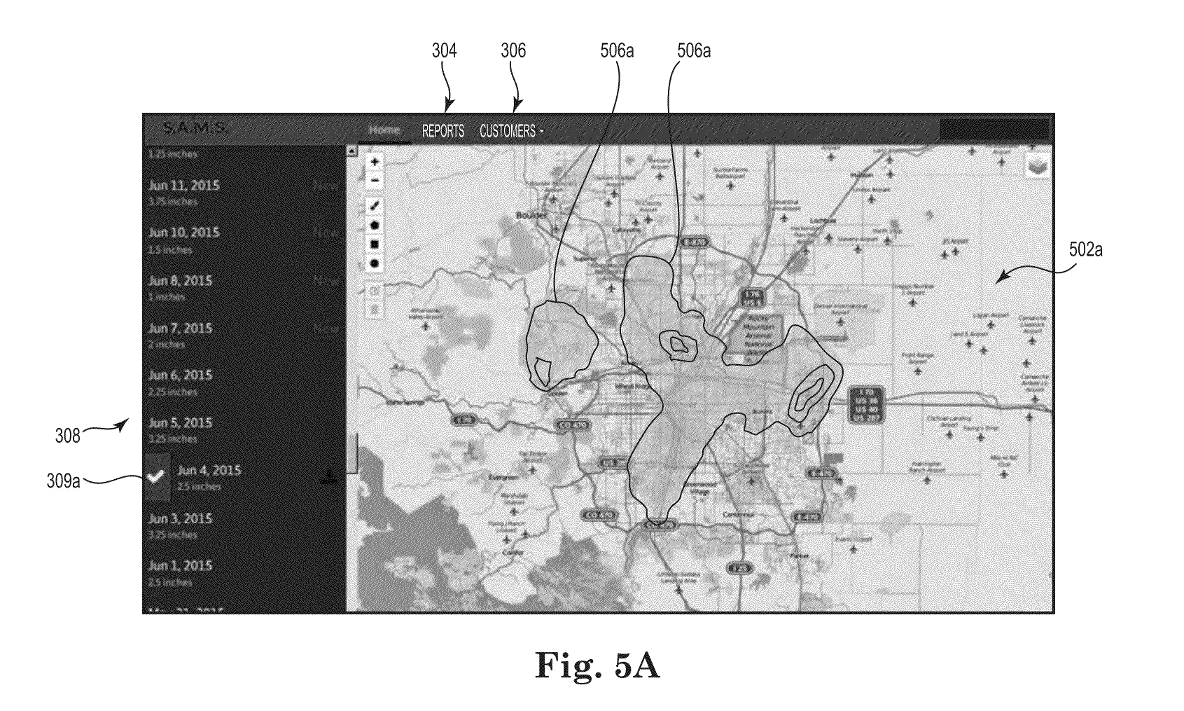

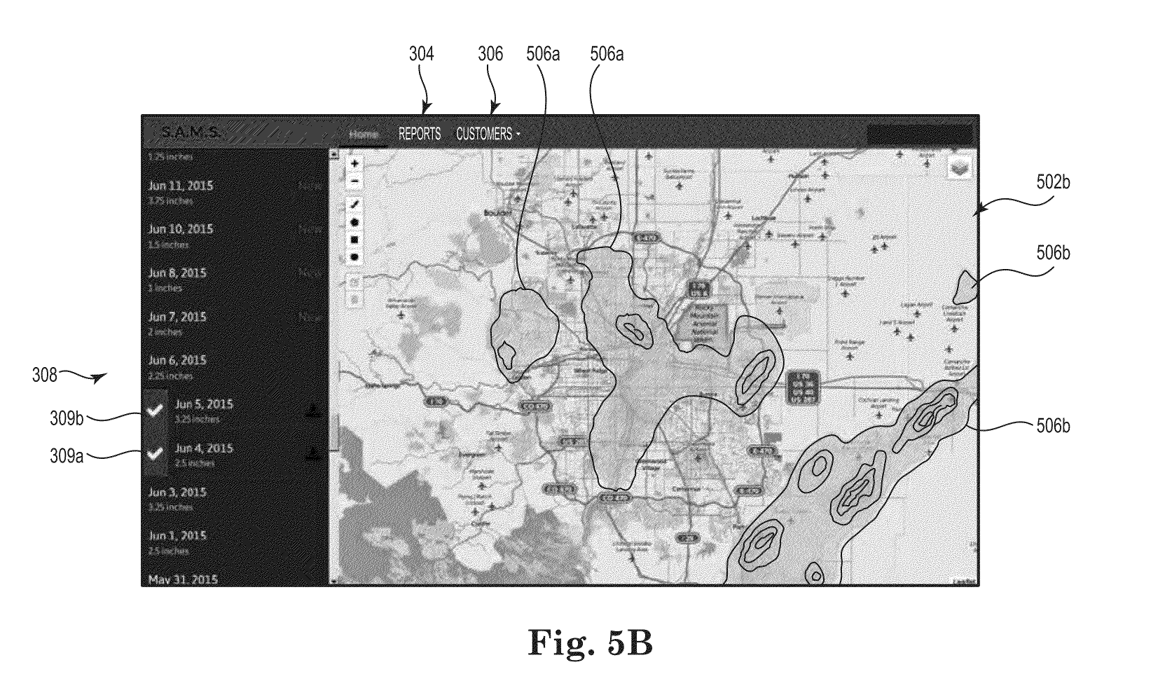

After at least one weather incident has been selected, the first map may be displayed with the first data from the at least one selected weather incident. FIG. 4 shows a first map 402 displayed within the map feature 302 of the selected territory screen 300. The first map 402 has a generally topographic or geographic background 404 and data points 406. In some embodiments, data points 406 may be shown as individual points or in at least the embodiment shown in FIG. 4, the data points may form areas or swaths, such as 406a and 406b. In some embodiments these areas 406a, 406b may color coded, or otherwise visually distinct, depending on the severity of the data; for example, in one embodiment, the darker (or lighter) the area, the more the severe the damage potential. For example, the darkest area may represent hail sizes of greater than 2 inches, which may be most likely to cause property damage requiring repair. In some embodiments, at least the data points may be obtained as a Keyhole Markup Language (KML) file format, OpenStreetMap data file format, or other file format used for expressing geographic annotation and visualization within map browsers such as, but not limited to, MapQuest, Google Maps, Google Earth, Mapbox, and Bing. The first map 402 comprises a first set of data points, shown generally at 406, related to weather incident data or other data related to real property as discussed above. In one embodiment, for example, the data points 406 may be obtained from National Oceanic and Atmospheric Administration data or other similar data source and the first set of data points may relate to hail stone accumulation and hail stone size or some other weather-related event(s). In some embodiments, the data points 406 may be obtained from any system capable of identifying geographic areas affected by a weather related event within a particular time interval and reporting that data to a database. In at least one embodiment, the system imports raw weather data from remote servers, analyzes the data to ensure accuracy, converts the data into boundaries of isometric proportions and is capable of outputting the results to a database in a GIS-compatible format. In at least one embodiment, the first map 402 may be limited to a particular user-specified territory or the map may be boundless, allowing a user to maneuver within the map and to zoom in and out of a particular region of the map. In at least one embodiment, the first set of data points may be limited to a specific time period (for example, the last hour, the last 24 hours, the last week, the last year) or the first set of data points may be an instantaneous snapshot of current conditions or information. The first set of data points may be continuously updated, or the user may select an update feature to refresh the first map. The first map, however, is not limited to only weather-related event(s), and in some embodiments, the first map 402 may alternatively or additionally include one or more other types of data related to real property such as, but not limited to, address information, property type information, property tax information, the borders of the property(ies), etc. While FIG. 4 shows a first map 402 with data from one selected weather incident 309, multiple weather incidents 309 may be selected and displayed, as shown in at FIGS. 5A and 5B. FIG. 5A shows a first map 502a with data from a selected first weather incident 309a and FIG. 5B shows a first map 502b with data from the selected first weather incident 309a and the selected second weather incident 309b. In some embodiments, multiple incidents may be displayed in an additive manner. For example, the areas or swaths 506a, 506b may overlap and intersect, creating a darker area on the map. The darker areas may help a user visually identify areas that may have sustained damage over multiple incidents and thus are at a greater risk for more severe damage caused to the property.

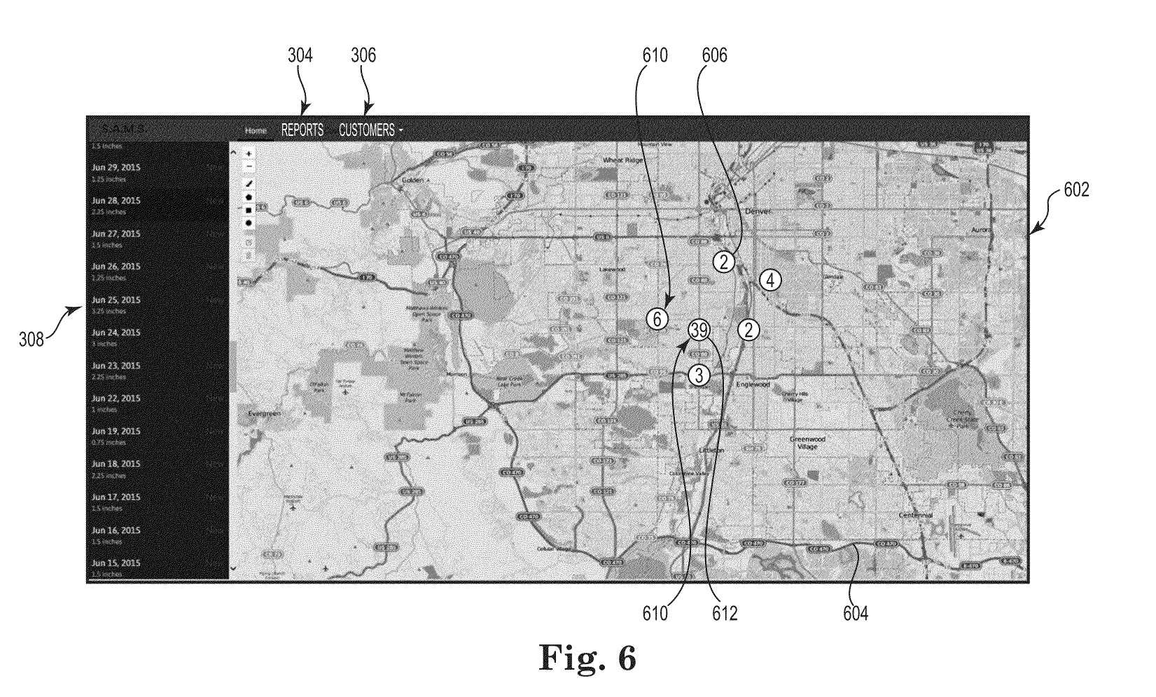

FIG. 6 shows an example of a second map 602 having a generally topographic or geographic background 604 and data points 606 derived from data obtained from a second database. Data points 606 may be shown as individual points but in some embodiments the data points may form areas. In some embodiments, at least the data points are geocoded data from CSV files that are converted into a format for viewing in a suitable map browser such as MapQuest, Google Maps, Google Earth, and Bing. The second map 602 comprises a second set of data points, shown generally at 606, related to a set of one or more user-selected characteristics as discussed above. In one embodiment, the data points relate to new, existing, or potential customer or consumer locations. In at least one embodiment, the second map 602 may be limited to a particular user-specified territory and/or other criteria contained within the first set of data points, or the map may be boundless, allowing a user to maneuver within the map. In at least one embodiment, the second map 602 may be limited to the same user-specified territory as the first map 402. The second set of data points may be continuously updated, or the user may select an update feature to refresh the second map. In some embodiments, the second map 602, by itself, may be utilized to collect or gather desired or selected information. For example, the second map 602 could be used alone to determine territory boundaries for the available territory, such as for but not limited to, sales or distributor territories, and the information could be extracted for output in a human-readable file format, as will be described further below. In some embodiments, such as the one shown in FIG. 6, data points 606 within a defined proximity of one another may be displayed as a cluster 610, which may feature a number 612 relative to the number of data points within the cluster and may be color coded based on the quantity of data points within the cluster. In at least one embodiment, when the user selects a cluster, the map feature zooms further into the area of that cluster and the cluster 610 bursts or separates into multiple clusters each having a smaller number of data points within each cluster and a smaller number displayed.

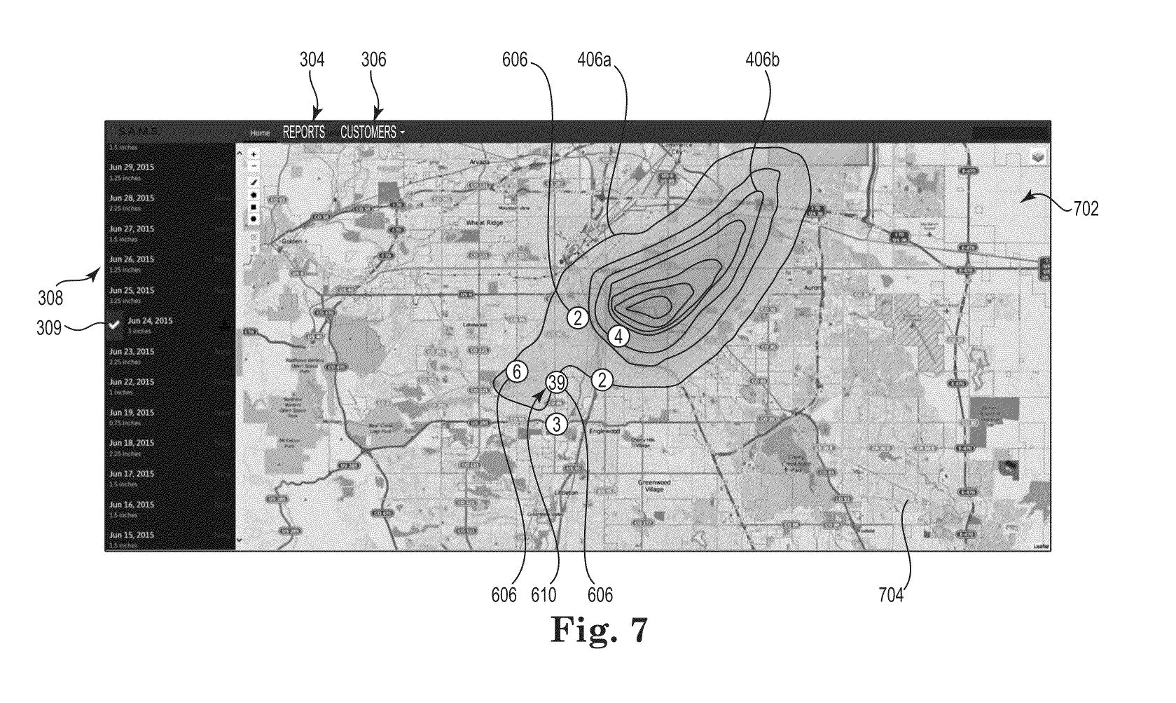

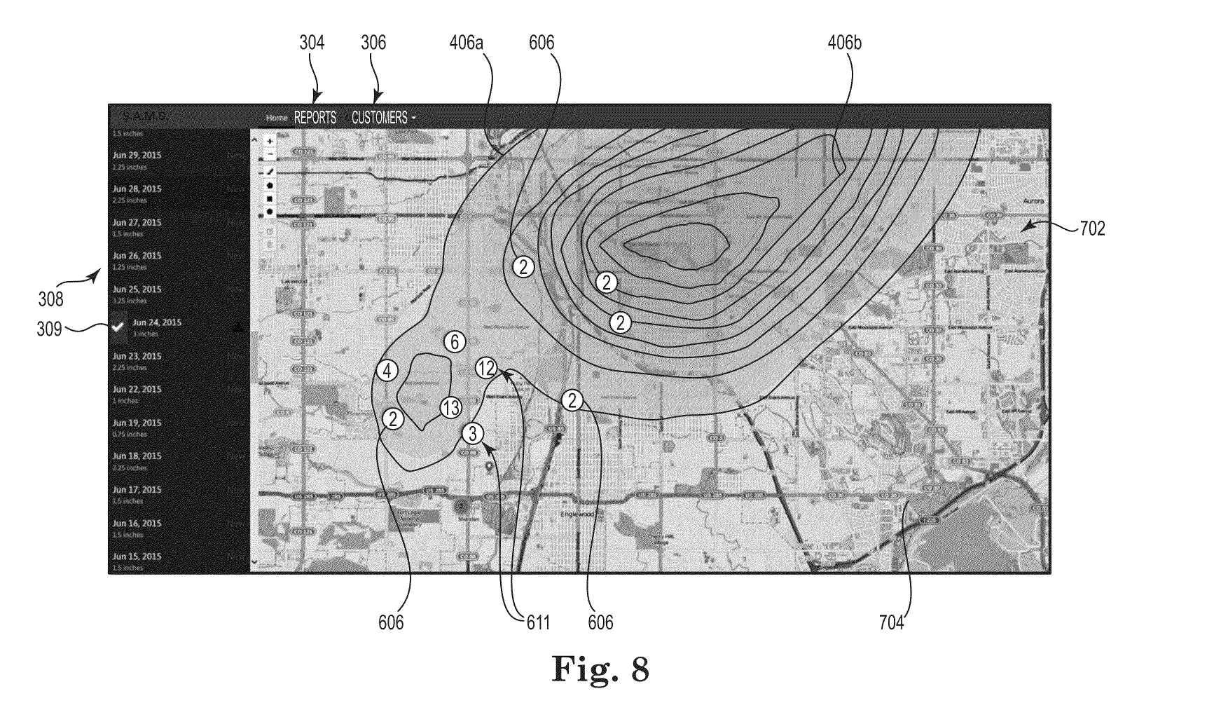

FIGS. 7-8 show an example of a third map 702 having a generally topographic or geographic background 704 and the combination of data points 406, 606 derived from data obtained from the first database and the second database, respectively. Where the data points 406 and the data points 606 intersect, a third set of data points can be generated. From the third set of data points, the user may obtain a list of each data point of the third set of data points, as shown in FIGS. 7-8. FIG. 8 shows the same third map 702 as FIG. 7, but in a view that is zoomed in on a smaller geographic section, and the cluster 610 shown in FIG. 7 has burst or separated into multiple clusters 611.

The generated list may in one embodiment be displayed as a table comprising a number of columns and a number of rows. The columns may display information regarding the third set data points, for example, an identifying reference number, the location, and the size of reported hail. Each row may relate to a specific property or a specific client or customer. In at least one embodiment, the outputted data includes information from the second database relating to the respective data points identified in the third set of data points. Additionally, the user may choose to output the data related to the third set of data points into a file format such as a Common-Separated Values (CSV) file format or other tabular file format. The generated list in the CSV file format may comprise a number of columns displaying information regarding the third set of data points, for example, an identifying reference number, contact information including the address, the city, the state, the zip code, the name of the property owner, renter, or occupant, the contact phone number, the date last visited, the property's shingle type, and the property's shingle color, whether the property has a finished or unfinished basement, and/or any other property information such as but not limited to siding information, window information, landscaping information, etc. In some embodiments, the generated list may include vehicle information for cars, trucks, boats, motorcycles, and/or recreational vehicles owned and/or registered by the specific client or customer or registered to the property. In one embodiment, one of the user-selected characteristics for the generated list is the property's shingle type and/or the property's siding type, obtained from the second database. By selecting the property's shingle type and, if desired, further sorting the list by shingle color, a representative may, for example, choose to visit only those properties with a specific shingle type and color found to have a manufacture recognized defect or those properties for which the representative has the specific shingle or siding type and color readily available. However, other uses of this information are contemplated, and it is recognized that various other characteristics of a property can be used to further filter the third set of data points in this manner.

In at least one embodiment, the user may select a download button for each selected weather incident 309 and automatically generate a list of all customers, clients, or properties that fall within the selected weather incident 309.

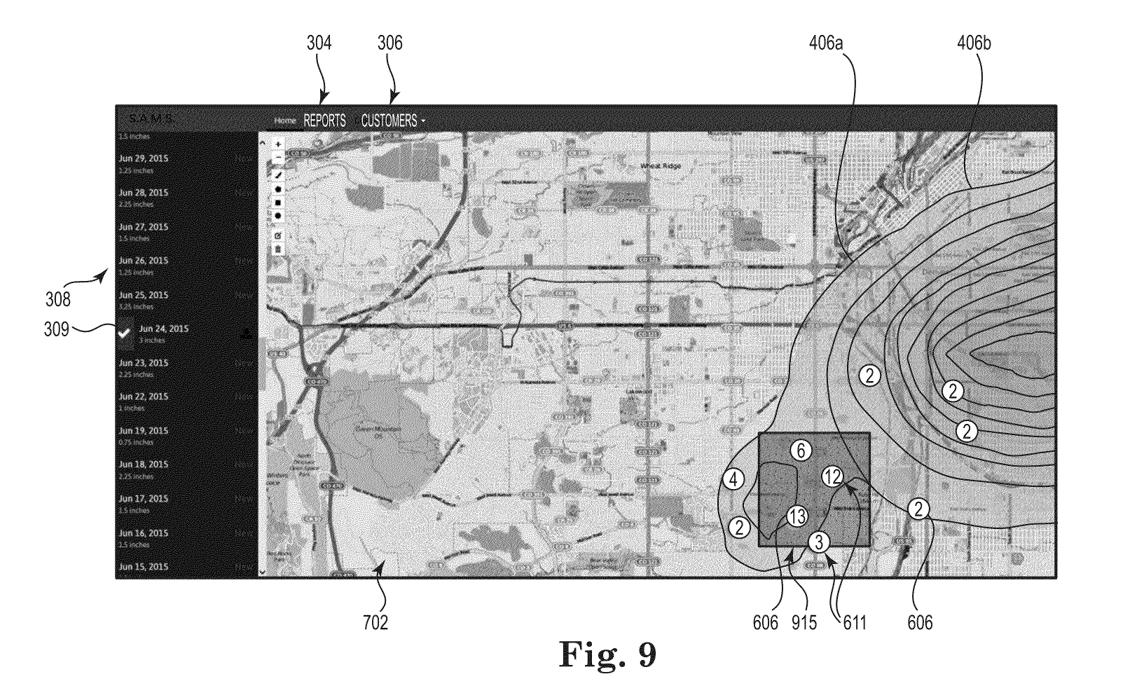

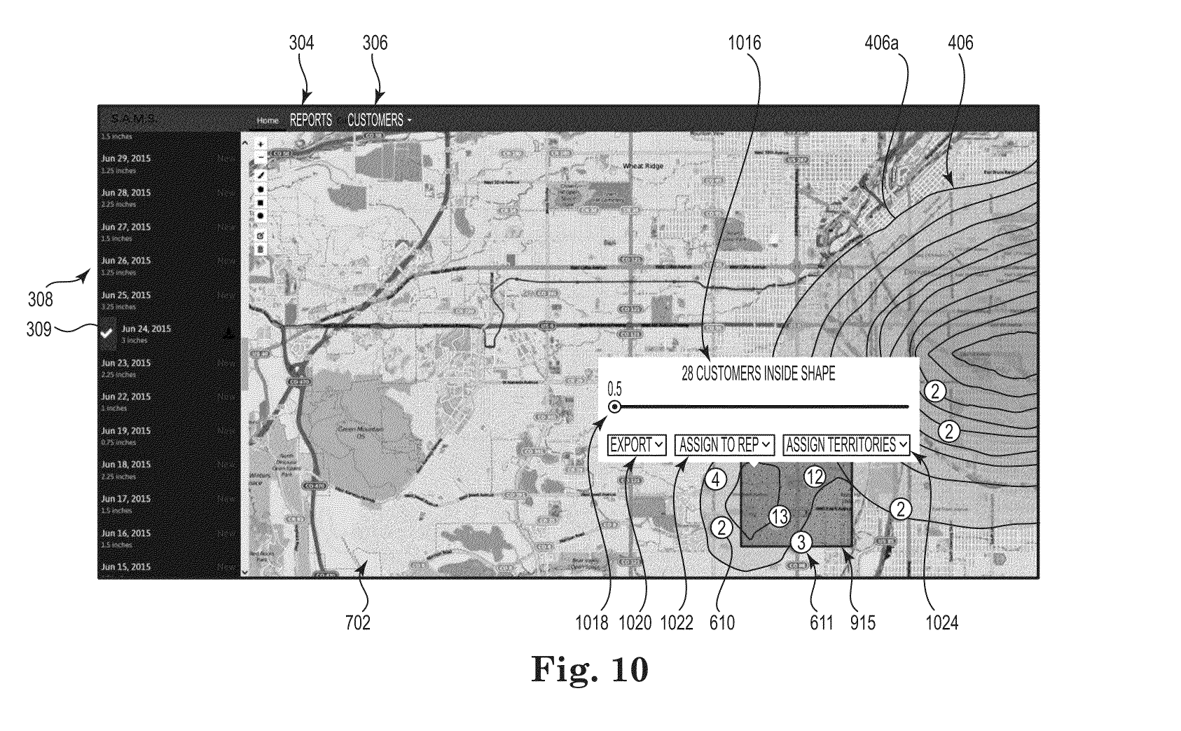

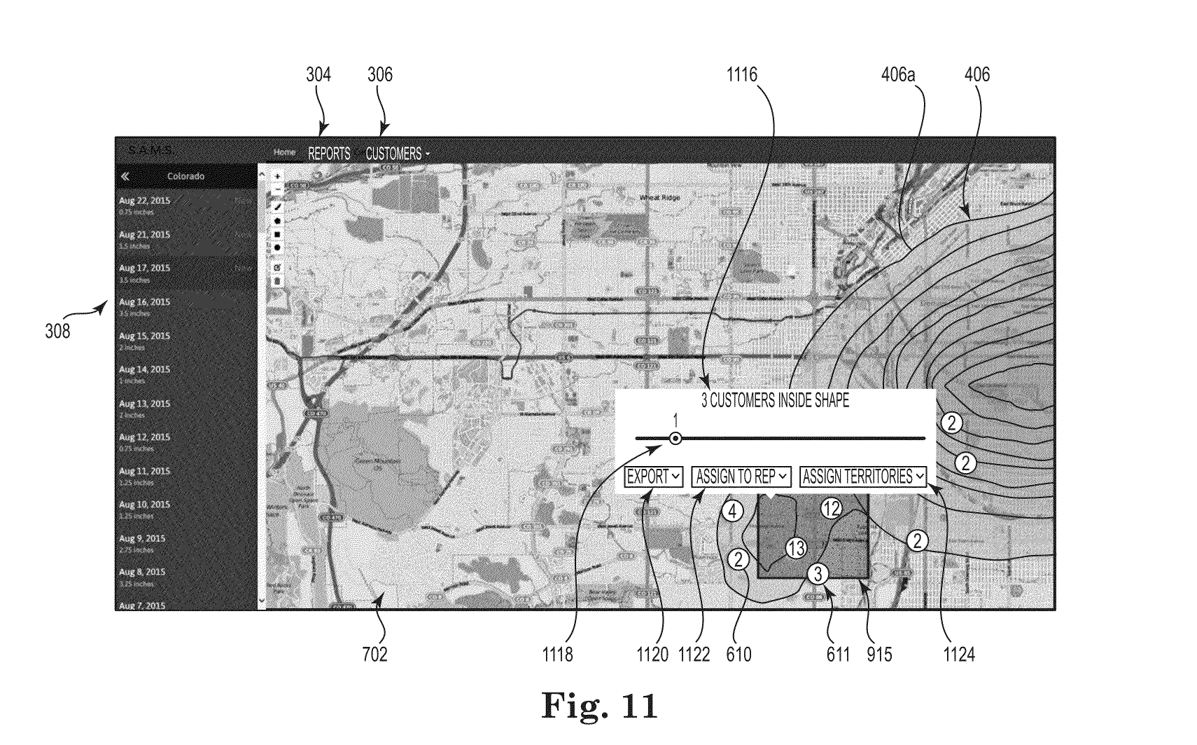

In at least one embodiment, as shown in FIGS. 9-11, the user may select a specific region 915 of the third map to generate a region-specific targeted list, by, for instance, selecting certain criteria within, about, or related to the first set of data points, drawing a perimeter around the desired area or visually highlighting the desired area using a drawing tool platform. In some embodiments, the specific region may be automatically generated by the system, and in other embodiments, the specific region may be manually generated by the user. One method of automatically generating a specific region is disclosed in U.S. Pat. Nos. 7,949,548 and 8,386,280, the contents of which are hereby incorporated herein by reference in their entirety. Additionally, the user may choose to output the data related to the region-specific targeted list into a file format such as a Common-Separated Values (CSV) file format or other tabular file format. As shown in FIGS. 10-11, the interface may display, as shown at 1016, the number of data points of the third set of data points inside the specific region 915. As further shown in FIGS. 10-11, the user can select a particular criteria, such as hail size, with selection feature 1018, 1118. By selecting the particular criteria, the number of data points of the third set of data points inside the specific region 915, as displayed at 1016, 1116+, will be updated to show the intersection between the first data points and the second data points based on that particular criteria that the user selected with selection feature 1018, 1118. For example, as shown in FIGS. 10-11, FIG. 10 shows selection feature 1018 with a hail size of at least 0.5 inches and displays 28 customers meeting that criteria within the region 915, while FIG. 11 shows selection feature 1018 with a hail size of at least 1.0 inches and displays 3 customers meeting that criteria within the region 915. As a result, the region-specific targeted list may be updated according to the criteria defined by the selection feature. The user may then choose to output the data related to the region-specific targeted list into a file format such as a Common-Separated Values (CSV) file format or other tabular file format using the export function shown at 1020, 1120. Additionally, the user may assign the region-specific targeted list to a particular sales representative using a representative assignment function as shown at 1022, 1122.

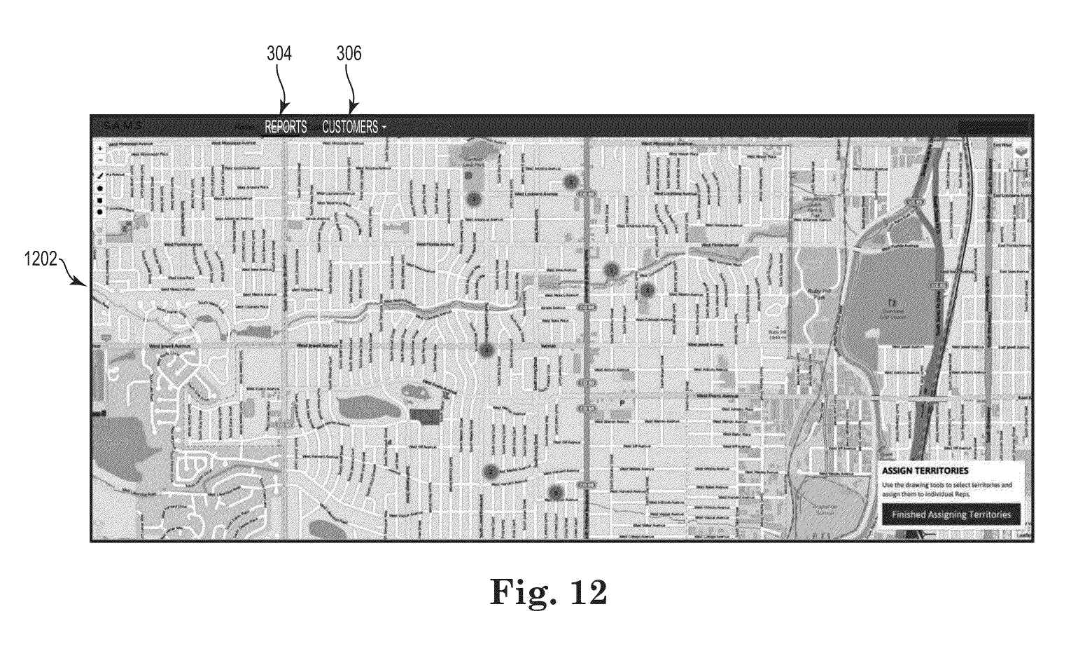

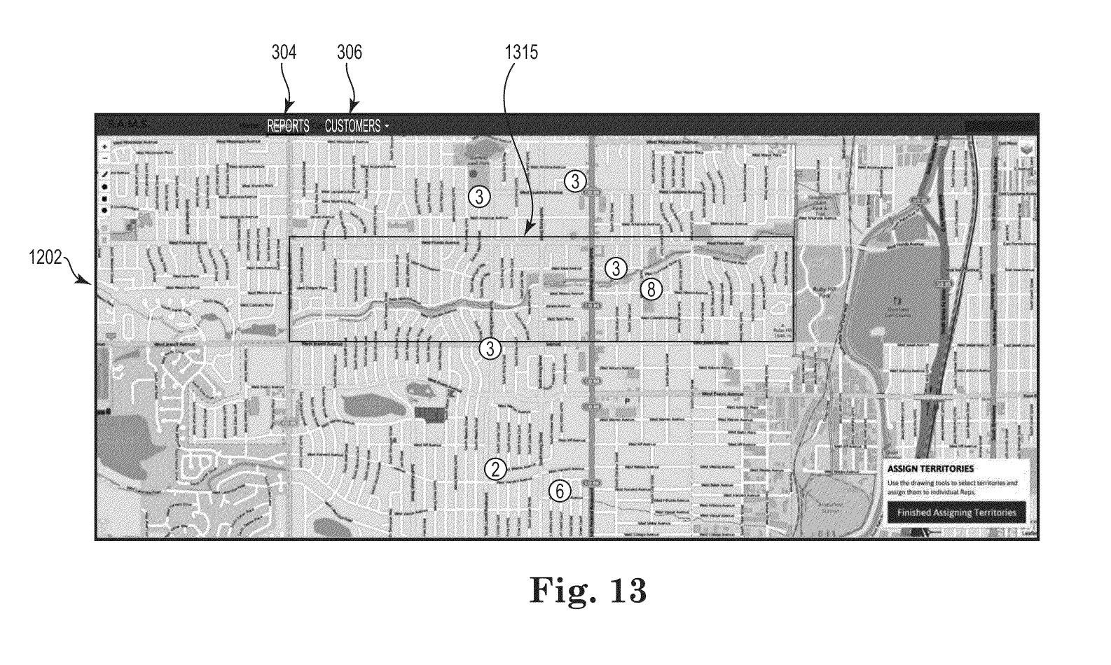

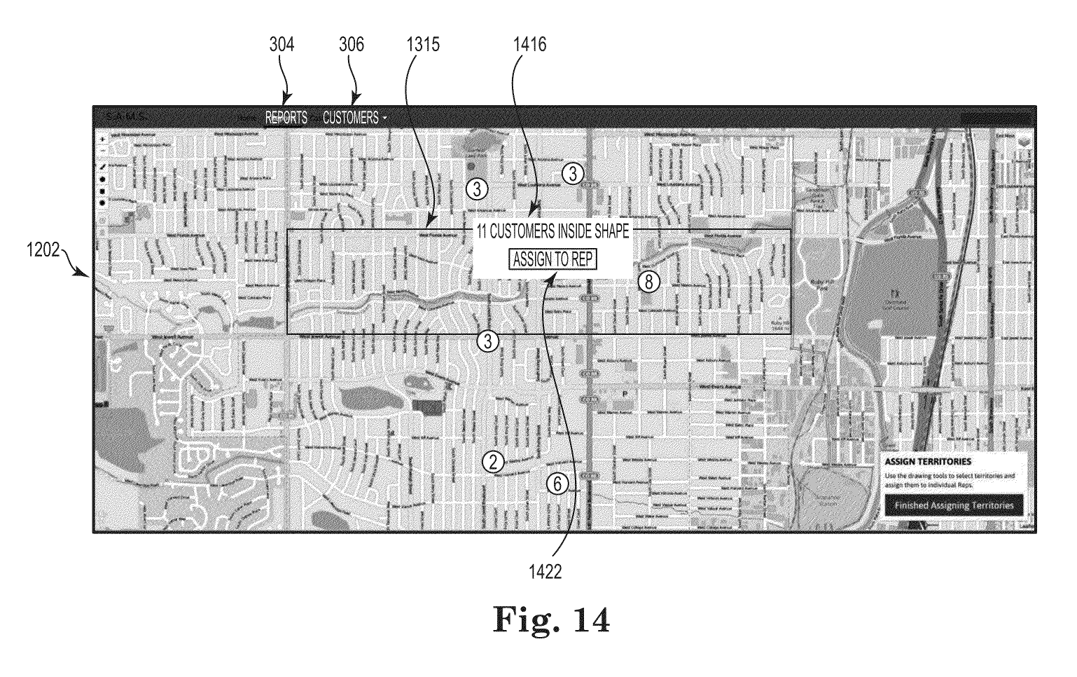

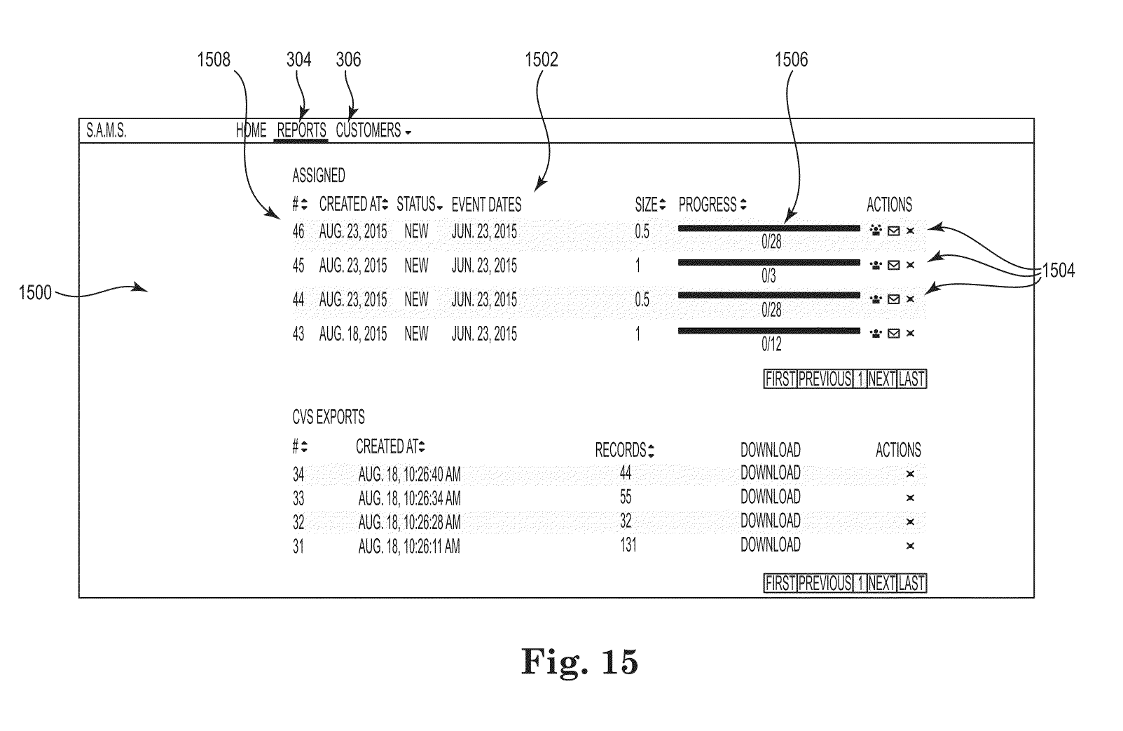

The user may also assign the region-specific targeted list to a sales representative using a territory assignment function as shown at 1024, 1124. As shown in FIGS. 12-14, a map 1202 may be displayed and the map 1202 may be relative to the specific region 915 previously selected, or may be relative to the users meeting the particular criteria selected as discussed above, or may be a new map. As shown in FIG. 13, the user may select a specific region 1315 of the map 1202 to define a sales territory, by, for instance, selecting certain criteria within, about, or related to the first set of data points, drawing a perimeter around the desired area or visually highlighting the desired area using a drawing tool platform. In at least the embodiment shown in FIG. 14, the interface may display, as shown at 1416, the number of data points of the third set of data points inside the specific region 1315. The user may then assign the region-specific targeted list to a particular sales representative using a representative assignment function as shown at 1422. The user may follow these steps to select, or to define and then assign, one or more territories as part of an assigned list. In at least one embodiment, when the user is done assigning territories, a reports screen 1500 is displayed as shown in FIG. 15. In at least one embodiment, the user may access the reports screen 1500 at any time by selecting the reporting feature 204, 304 as shown in at least FIGS. 2-11. Reports screen 1500 may display the assigned lists as shown at 1502. In at least one embodiment, the user may be able to email each assigned list, share each assigned list, or delete each assigned list, as shown generally at 1504. In at least one embodiment, the user may be able to track progress in contacting the customers or clients or visiting the properties on each assigned list, as shown generally at 1506. Reports screen may also display a list of the assigned lists created by the user as shown at 1508. In at least one embodiment, a user and/or a representative may receive automatically generated notifications of customers, properties, and clients within the region-specific targeted list for the territories assigned by the user to the representative.

Using the third set of data points of the third map, the user may plot an itinerary onto the map, wherein the itinerary may have a starting point based on an initial set of geographic coordinates of the user. In some embodiments, the itinerary may be automatically generated by the system, and in other embodiments, the itinerary may be manually generated by the user.

In at least one embodiment, depending on whether a third party data point is visited by a sales representative, inspected, called, or sent a mailing, the second database is automatically updated to reflect this action.

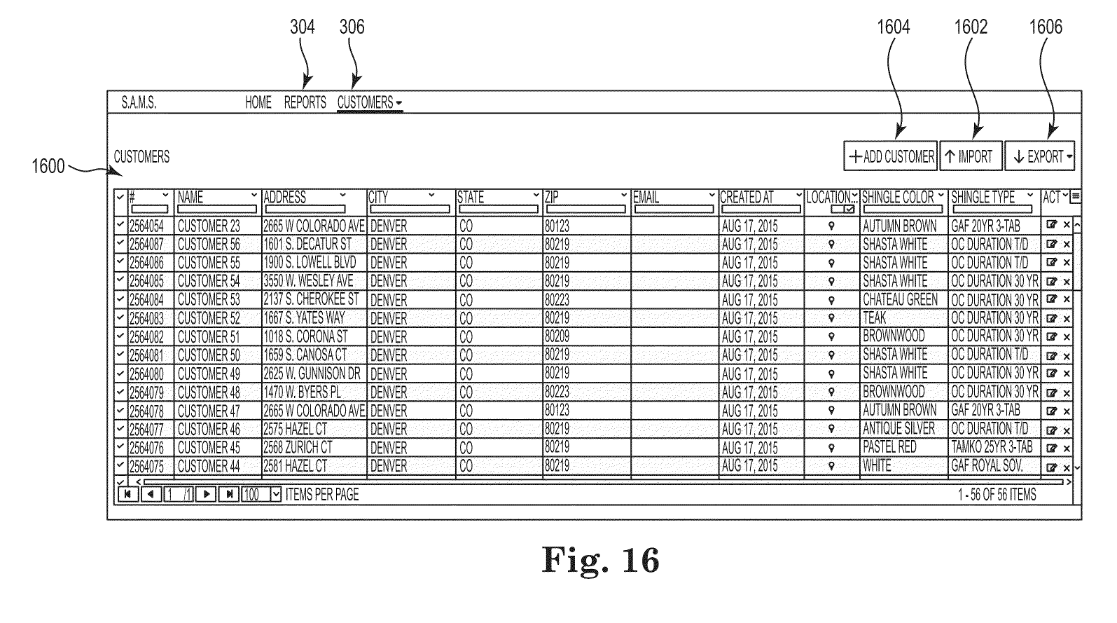

In some embodiments, the second data points (representing properties, or customers, or clients) may be inputted, outputted, or updated in the second database through customer feature 206, 306 of the interface. In at least one embodiment, the interface comprises a customer viewing screen 1600 as shown in FIG. 16. A user may import a list from a CSV file or other tabular file, at least in one embodiment by way of the import feature 1602, which is then displayed within customer viewing screen 1600. In at least one embodiment, multiple customer lists can be inputted in the second database and displayed on the map with different colors or icons by assigning different colors or icons to each customer list. The list may be displayed in a tabular format as shown at FIG. 16. In at least one embodiment, the displayed categories of information, which may be displayed as column headers in the list, may be editable such that displayed categories can be added or deleted from the viewing screen 1600. In at least one embodiment, the list is searchable. The user may filter the list by selecting one or more criteria including but not limited to address, city, state, zip code, shingle color, shingle type, last visited, current customer, former customer, or any other database filter. After filtering the list, the user may return to the map 702 and the data points will automatically update to only display the filtered list. The user may define each of these criteria, which can be associated with any customer list. The user may add another property, customer, or client to the list by selecting the add feature 1604. The user may also edit any property, customer, or client within the list with updated information. In at least one embodiment, the displayed information may be automatically updated or edited with data regarding the property, customer, or client based on data received from a third party database, including but not limited to a construction industry-related database, a county property tax database, a real estate database, a telephone listing database, or other public information database. A user may also export the list to a CSV file or other tabular file using the export feature 1606.

In the foregoing description, various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method of generating a list of targeted customers within a territory affected by a severe weather incident, the method comprising:
retrieving severe weather incident data for at least one severe weather incident from a first database, the severe weather incident data comprising weather data points defining a severe weather pattern;
retrieving customer data from a second database, the customer data comprising data for each of a plurality of customers, and for each customer a customer data point defining a geographic location related to that respective customer;
displaying the customer data points and the severe weather pattern onto a map viewable by a user, wherein the customer data points are geocoded for display on the map; and
transmitting a targeted customer list, wherein the targeted customer list is determined by at least one user-selected parameter and the intersection of customer data points with weather data points.

2. The method of claim 1, wherein the at least one user-selected parameter is a selected region of the map to further limit the targeted customer list to the selected region.

3. The method of claim 1, wherein the severe weather incident data comprises data related to hail.

4. The method of claim 3, wherein the at least one user-selected parameter is hailstone size.

5. The method of claim 1, wherein the severe weather incident data comprises data related to damaging winds.

6. The method of claim 5, wherein the at least one user-selected parameter is wind speeds.

7. The method of claim 1, wherein the severe weather incident data comprises data related to snow.

8. The method of claim 7, wherein the at least one user-selected parameter is snow depth.

9. The method of claim 1, wherein the severe weather incident data comprises data related to rain.

10. The method of claim 9, wherein the at least one user-selected parameter is an amount of rainfall during the severe weather incident.

11. The method of claim 1, wherein the user-selected characteristics comprises at least one of existing customers, past customers, new customers, user-managed properties, referral source, dates and times of scheduled inspections, number of call attempts, roofing materials, siding materials, and driveway materials.

12. The method of claim 1, wherein the at least one user-selected parameter comprises all severe weather incident data for a selected date.

13. The method of claim 1, further comprising generating an alert from the targeted customer list to alert a user to visit a property.

14. The method of claim 1, further comprising assigning the targeted customer list to a representative for the territory.

15. The method of claim 1, wherein the customer data is automatically updated from information retrieved from a third party database.

16. A method of generating a list of targeted customers within a specified region of a territory, the method comprising:
retrieving severe weather incident data for at least one severe weather incident from a first database, the severe weather incident data comprising weather data points defining a severe weather pattern;
retrieving customer data from a second database, the customer data comprising customer data points;
displaying the customer data points and the severe weather pattern onto a map viewable by a user, wherein the customer data points are geocoded for display on the map;
retrieving boundary information for a region within the map selected by a user; and
transmitting a targeted customer list to the user, wherein the targeted customer list is determined by the intersection of customer data points with weather data points and the boundary information for the region.

17. The method of claim 16, wherein weather incident data comprises data related to at least one of hail accumulation, hailstone size, snow accumulation, flooding, wind gusts, sustained high winds, lightning strikes, severe storm paths, tornado paths, hurricane paths, and seismic activity.

18. The method of claim 16, further comprising assigning the targeted customer list to a representative.

19. The method of claim 16, wherein the targeted customer list is further determined by at least one user-selected characteristic.

20. The method of claim 19, wherein the user-selected characteristics comprise at least one of existing customers, past customers, new customers, user-managed properties, referral source, dates and times of scheduled inspections, number of call attempts, roofing materials, siding materials, and driveway materials.
